(19) United States
(12) Patent Application Publication
(10) Pub. No.: US 2025/0050655 A1
(43) Pub. Date: Feb. 13, 2025

(54) IMAGE FORMING APPARATUS AND IMAGE FORMING METHOD

(71) Applicant: KYOCERA Document Solutions Inc., Osaka (JP)

(72) Inventor: Shinji Nakatsuka, Osaka (JP)

(21) Appl. No.: 18/790,259

(22) Filed: Jul. 31, 2024

(30) Foreign Application Priority Data
Aug. 8, 2023 (JP) 2023-128968
Aug. 8, 2023 (JP) 2023-128971

(51) Int. Cl. B41J 2/21; H04N 1/00

(52) U.S. Cl. CPC B41J 2/2135; B41J 2/2139; B41J 2/2142; B41J 2/2146; H04N 1/00015; H04N 1/00031; H04N 1/00045; H04N 1/00063

(57) ABSTRACT

An image forming apparatus includes an image forming portion, an image reading portion, and a test processing portion. The image forming portion forms an image on a sheet using a plurality of recording elements. The image reading portion reads the image on the sheet. The test processing portion causes the image forming portion to form a test image in a marginal region of the sheet, and causes the image reading portion to read the test image. The test processing portion is capable of executing a divisional test in which only some of the plurality of recording elements are used for forming a single test image to be formed on a single sheet and all of the plurality of recording elements are used for forming a test image group constituted of a plurality of the test images to be formed on a plurality of the sheets.

### INCORPORATION BY REFERENCE

This application is based upon and claims the benefit of priority from the corresponding Japanese Patent Application No. 2023-128968 and 2023-128971 filed on Aug. 8, 2023, the entire contents of which are incorporated herein by reference.

### BACKGROUND

The present disclosure relates to an image forming apparatus and an image forming method.

As the related art, there is known an image forming apparatus (an inkjet recording apparatus) having a function of detecting an ink ejection failure. In the image forming apparatus according to the related art, ink is ejected from each of a plurality of arranged nozzles onto a sheet (a recording medium), to thus form an image on the sheet. In this image forming apparatus, it is possible to adjust an ink ejection amount from adjacent nozzles based on a test result of an ink ejection state of the nozzles, to thus compensate for lowering of quality of a formed image that is due to the ink ejection failure of the nozzles.

In the image forming apparatus according to the related art, a test of the ink ejection state includes ejecting ink onto a sheet from a plurality of nozzles, forming a halftone image having a predetermined concentration on the sheet as a test image (a test image), and reading the test image. Then, this image forming apparatus determines whether or not there is an ink ejection failure of the nozzles based on a contrasting density of the read test image.

### SUMMARY

An image forming apparatus according to an aspect of the present disclosure includes an image forming portion, an image reading portion, and a test processing portion. The image forming portion forms an image on a sheet using a plurality of recording elements. The image reading portion reads the image on the sheet. The test processing portion causes the image forming portion to form a test image in a marginal region of the sheet, and causes the image reading portion to read the test image. The test processing portion is capable of executing a divisional test in which only some of the plurality of recording elements are used for forming a single test image to be formed on a single sheet and all of the plurality of recording elements are used for forming a test image group constituted of a plurality of the test images to be formed on a plurality of the sheets.

An image forming method according to another aspect of the present disclosure includes: image forming processing for causing an image forming portion which forms an image on a sheet using a plurality of recording elements to form a test image in a marginal region of the sheet; and image reading processing for reading the test image. In the image forming processing, only some of the plurality of recording elements are used for forming a single test image to be formed on a single sheet, and all of the plurality of recording elements are used for forming a test image group constituted of a plurality of the test images to be formed on a plurality of the sheets.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an image forming system according to Embodiment 1;

FIG. 2 is a block diagram showing a configuration of an image forming apparatus according to Embodiment 1;

FIG. 3 is a schematic diagram showing a configuration of an image forming portion of the image forming apparatus according to Embodiment 1;

FIG. 4 is a schematic diagram showing an example of test processing executed in the image forming apparatus according to Embodiment 1;

FIG. 5 is a schematic diagram showing an example of the test processing executed in the image forming apparatus according to Embodiment 1;

FIG. 6 is a schematic diagram showing an example of the test processing executed in the image forming apparatus according to Embodiment 1;

FIG. 7 is a schematic diagram showing an example of the test processing executed in the image forming apparatus according to Embodiment 1;

FIG. 8 is a schematic diagram showing an example of the test processing executed in the image forming apparatus according to Embodiment 1;

FIG. 9 is a schematic diagram showing an example of the test processing executed in the image forming apparatus according to Embodiment 1;

FIG. 10 is a flowchart showing an operation example of a test processing portion in the image forming apparatus according to Embodiment 1;

FIG. 11 is a schematic diagram showing an example of test processing executed in an image forming apparatus according to Embodiment 2;

FIG. 12 is a schematic diagram showing an example of the test processing executed in the image forming apparatus according to Embodiment 2;

FIG. 13 is a schematic diagram showing an example of the test processing executed in the image forming apparatus according to Embodiment 2;

FIG. 14 is a schematic diagram showing a configuration of an image forming system according to Embodiment 3;

FIG. 15 is a schematic diagram showing an example of test processing executed in the image forming system according to Embodiment 3;

FIG. 16 is a flowchart showing an operation example of a test processing portion in the image forming system according to Embodiment 3; and

FIG. 17 is a schematic diagram showing a configuration of an image forming system according to Embodiment 4.

### DETAILED DESCRIPTION

Hereinafter, embodiments of the present disclosure will be described with reference to the attached drawings. It is noted that the following embodiments are each an example of embodying the present disclosure and do not limit the technical scope of the present disclosure.

### Embodiment 1

### [1] Overall Configuration of Image Forming Apparatus

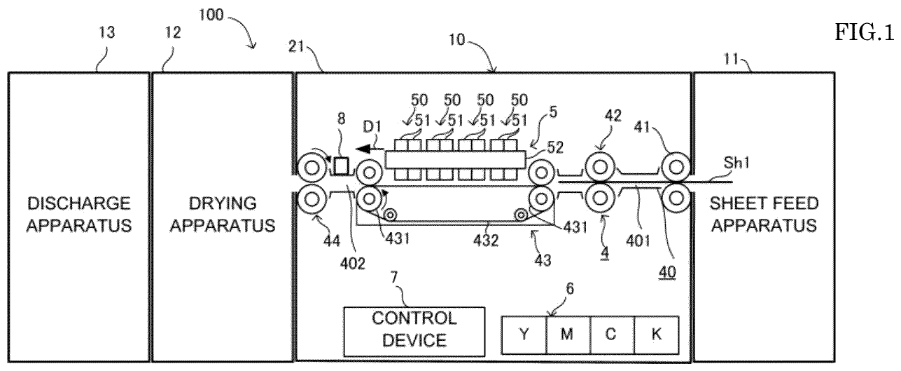

First, an overall configuration of an image forming apparatus 10 according to the present embodiment will be described with reference to FIG. 1 to FIG. 3.

In the present embodiment, as an example, the image forming apparatus 10 is an inkjet recording apparatus (a printer) which includes recording heads 51 that eject ink onto a front surface of a sheet Sh1 and is capable of executing print processing using an inkjet system for forming an image on the sheet Sh1 using the recording heads 51. The print processing is processing of forming an image on an image forming target. The sheet Sh1 is an example of the image forming target (a recording medium) on which an image is formed in the image forming apparatus 10 and is a sheet-type medium such as paper and a resin film.

The image forming apparatus 10 only needs to have a function of forming an image using the inkjet system and may be, for example, a multifunction peripheral having a plurality of functions such as a scanning function, a facsimile function, and a copying function for reading image data from a document sheet in addition to a printing function. Alternatively, the image forming apparatus 10 may be a facsimile apparatus, a copying machine, or the like.

As shown in FIG. 1, the image forming apparatus 10 configures an image forming system 100 together with a sheet feed apparatus 11, a drying apparatus 12, and a discharge apparatus 13. In other words, the image forming system 100 according to the present embodiment includes the image forming apparatus 10, the sheet feed apparatus 11, the drying apparatus 12, the discharge apparatus 13, and the like. Herein, the image forming apparatus 10, the sheet feed apparatus 11, the drying apparatus 12, and the discharge apparatus 13 are connected in the stated order of the sheet feed apparatus 11, the image forming apparatus 10, the drying apparatus 12, and the discharge apparatus 13 from an upstream side of a conveying direction of the sheet Sh1. Thus, the image forming system 100 can consecutively perform, with respect to the sheet Sh1, a series of processing carried out by the sheet feed apparatus 11, the image forming apparatus 10, the drying apparatus 12, and the discharge apparatus 13. In addition, the respective apparatuses of the image forming system 100 are collectively managed by a control device 7 of the image forming apparatus 10. It is noted that without being limited to this configuration, a control device which collectively manages the respective apparatuses may be provided separate from the control device 7.

The sheet feed apparatus 11 is capable of storing a plurality of sheets Sh1. The sheet feed apparatus 11 supplies the sheets Sh1 one by one to the image forming apparatus 10. The image forming apparatus 10 ejects ink from the recording heads 51 onto the sheet Sh1 supplied from the sheet feed apparatus 11 to thus form an image by the inkjet system (an ink image). The image forming apparatus 10 feeds the sheet Sh1 on which the image has been formed to the subsequent drying apparatus 12.

The drying apparatus 12 includes a drying chamber inside and includes, in the drying chamber, a heater, a heating unit that uses a heat pump system, or the like. The drying apparatus 12 heats the front surface of the sheet Sh1 conveyed into the drying chamber from the image forming apparatus 10 to dry the ink image formed on the sheet Sh1. The drying apparatus 12 includes an exhaust fan for exhausting (discharging) moisture from the drying chamber. The drying apparatus 12 feeds the sheet Sh1 that has been subjected to drying processing to the subsequent discharge apparatus 13. Thus, the sheet Sh1 on which the image has been formed by the inkjet system in the image forming apparatus 10 is discharged to the discharge apparatus 13.

The discharge apparatus 13 stocks the sheets Sh1 conveyed from the drying apparatus 12. In addition, the discharge apparatus 13 may have, for example, a post-processing function such as a staple function and a punch function. In this case, in the discharge apparatus 13, appropriate post-processing can be performed on the sheet Sh1 on which the image has already been formed. Further, although the sheet Sh1 that has been subjected to the drying processing in the drying apparatus 12 is conveyed to the discharge apparatus 13 in one-side printing in which an image is formed only on one side of the sheet Sh1, in duplex printing in which images are formed on both sides of the sheet Sh1, the sheet Sh1 is fed back to the image forming apparatus 10 after being subjected to the drying processing in the drying apparatus 12. Then, after an image is formed on a back surface in the image forming apparatus 10 and subjected to the drying processing in the drying apparatus 12, the sheet Sh1 is conveyed to the discharge apparatus 13.

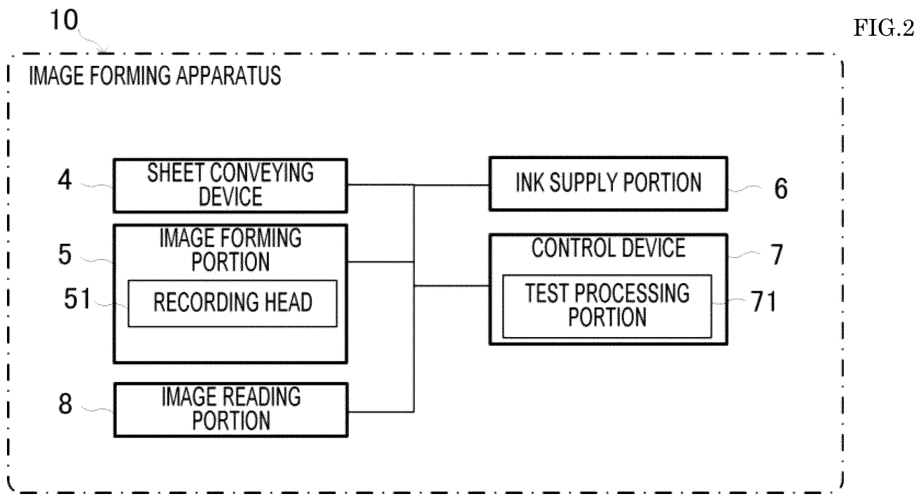

As shown in FIG. 1 and FIG. 2, the image forming apparatus 10 includes a sheet conveying device 4, an image forming portion 5, an ink supply portion 6, the control device 7, an image reading portion 8, and the like. The image forming portion 5 includes the plurality of recording heads 51. These sheet conveying device 4, image forming portion 5, ink supply portion 6, control device 7, image reading portion 8, and the like are housed in a housing 21 that constitutes an outer frame of the image forming apparatus 10.

The sheet conveying device 4 conveys the sheets Sh1 supplied from the sheet feed apparatus 11 one by one via a conveying path 40. Thus, the sheet Sh1 taken into the housing 21 of the image forming apparatus 10 from the sheet feed apparatus 11 passes below the image forming portion 5 via the conveying path 40 to be conveyed in a conveying direction D1 and discharged to the drying apparatus 12. The conveying path 40 is a path for conveying the sheet Sh1 inside the housing 21 and includes a preceding conveying path 401 on the upstream side and a subsequent conveying path 402 on the downstream side with respect to the image forming portion 5. The sheet conveying device 4 conveys the sheet Sh1 supplied from the sheet feed apparatus 11 to the image forming portion 5 via the preceding conveying path 401 and discharges the sheet Sh1 from the image forming portion 5 to the drying apparatus 12 via the subsequent conveying path 402.

The sheet conveying device 4 includes a sheet feed portion 41, one or more preceding conveying roller pairs 42, a main conveying unit 43, a discharge roller pair 44, and the like. The sheet feed portion 41 feeds the sheets Sh1 supplied from the sheet feed apparatus 11 one by one to the preceding conveying path 401. The plurality of preceding conveying roller pairs 42 take over the conveyance of the sheet Sh1 from the sheet feed portion 41 and convey the sheet Sh1 toward the main conveying unit 43.

The main conveying unit 43 is arranged below the image forming portion 5. The preceding conveying path 401 is a path that reaches a position below the image forming portion 5 (above the main conveying unit 43) from the sheet feed apparatus 11. The main conveying unit 43 conveys the sheet Sh1 while causing a first surface (a front surface) of the sheet Sh1 to oppose the image forming portion 5. The first surface of the sheet Sh1 is a surface on which an ink image is formed. The main conveying unit 43 includes a plurality of tension rollers 431 and a main conveying belt 432, and the main conveying belt 432 is supported and rotated by the plurality of tension rollers 431. Thus, the main conveying unit 43 conveys the sheet Sh1 toward the discharge roller pair 44 while the sheet Sh1 is placed on the main conveying belt 432.

The discharge roller pair 44 discharges the sheet Sh1 on which an ink image has been formed to the drying apparatus 12. The subsequent conveying path 402 is a path that reaches the drying apparatus 12 from the position below the image forming portion 5 (above the main conveying unit 43).

The image forming portion 5 is arranged above the main conveying unit 43. The image forming portion 5 ejects ink of a plurality of colors toward the sheet Sh1 conveyed by the main conveying unit 43 of the sheet conveying device 4, to thus form an ink image on the first surface of the sheet Sh1.

The image forming portion 5 includes the plurality of recording heads 51 and a head frame 52 that supports the plurality of recording heads 51. The plurality of recording heads 51 eject the ink of the plurality of colors toward the sheet Sh1 conveyed by the main conveying unit 43, to thus form an image on the sheet Sh1.

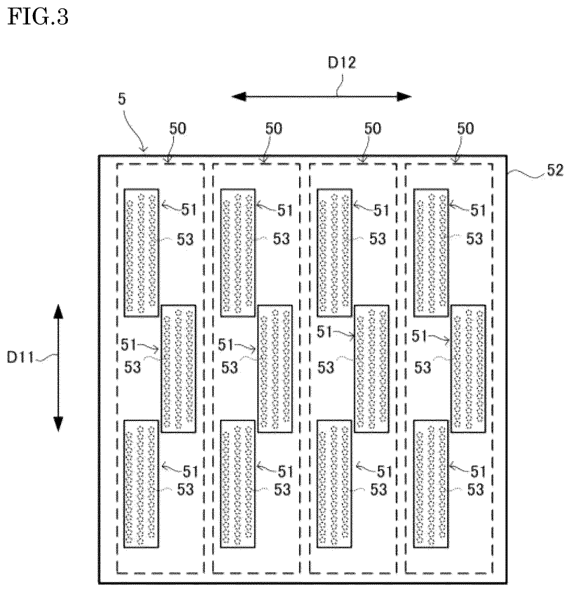

In the example of FIG. 1, the plurality of recording heads 51 are sectioned into four line heads 50 respectively corresponding to ink in respective colors of black, cyan, magenta, and yellow. The ink supply portion 6 supplies the ink of the respective colors (K, C, M, and Y) to the recording heads 51 of the corresponding line heads 50. The four line heads 50 are arranged next to one another in a sub-scanning direction D12 and are fixed in a predetermined positional relationship (see FIG. 3). The number of line heads 50 to be provided in the image forming portion 5 is not limited to four and may be, for example, two, three, or five or more. The sub-scanning direction D12 is the same as the conveying direction D1 of the sheet Sh1 on the main conveying belt 432.

The plurality of recording heads 51 are arranged at positions at which a gap of about 1 millimeter is formed between an ink ejection surface provided on lower surfaces thereof and an upper surface of the sheet Sh1 on the main conveying belt 432. As shown in FIG. 3, the plurality of recording heads 51 are each arranged in a state where a longitudinal direction thereof is provided along a main scanning direction D11. In the present embodiment, as an example, the line heads 50 of the respective colors each include three recording heads 51. A plurality of ink nozzles 53 that eject ink onto the sheet Sh1 conveyed along the conveying path 40 are formed on the ink ejection surface of each of the recording heads 51. Each of the recording heads 51 includes a plurality of piezoelectric elements corresponding to the plurality of ink nozzles 53. Each of the piezoelectric elements oscillates when a drive signal is supplied from the control device 7, and thus the ink is pressurized to be ejected (blown out) from the respective ink nozzles 53.

The image reading portion 8 reads an image on the sheet Sh1. The image reading portion 8 reads an image from the sheet Sh1 and outputs image data corresponding to the read image to the control device 7. The image reading portion 8 includes a light source, a plurality of mirrors, an optical lens, a CCD (Charge Coupled Device), and the like.

In the present embodiment, the image reading portion 8 is positioned above the subsequent conveying path 402. The image reading portion 8 is arranged more on the downstream side of the conveying direction D1 of the sheet Sh1 by the sheet conveying device 4 than the image forming portion 5. Thus, the image reading portion 8 can read the image formed on the sheet Sh1 by the image forming portion 5 at a position on the downstream side. In other words, while the sheet Sh1 is conveyed by the sheet conveying device 4, formation of an image on the sheet Sh1 and reading of the image can both be performed.

The control device 7 collectively controls the image forming apparatus 10. The control device 7 includes, as a main configuration, a computer system including one or more processors and one or more nonvolatile memories. In the image forming apparatus 10, the one or more processors execute programs to realize functions of the control device 7. The programs may be recorded in advance in the memory (a storage portion), may be provided via an electric communication line such as the Internet, or may be provided by being recorded onto a non-transitory computer-system-readable recording medium such as a memory card and an optical disc. The one or more processors are configured by one or more electronic circuits including a semiconductor integrated circuit. In addition, the computer system used herein includes a microcontroller including one or more processors and one or more memories.

The control device 7 controls the sheet conveying device 4, the image forming portion 5, the ink supply portion 6, the image reading portion 8, and the like provided in the image forming apparatus 10. In other words, the control device 7 is electrically connected to the respective portions of the image forming apparatus 10 and is capable of, for example, controlling the image forming portion 5 to form a desired image on the sheet Sh1 and controlling the image reading portion 8 to read an image from the sheet Sh1. In other words, the control device 7 executes an image forming program recorded in the memory to perform an image forming method for controlling the respective portions of the image forming apparatus 10.

In the present embodiment, the control device 7 has at least a function of a test processing portion 71 as shown in FIG. 2. The test processing portion 71 performs a test of an operation state of the image forming portion 5. The test processing portion 71 controls the image forming portion 5 to form a test image on the sheet Sh1, controls the image reading portion 8 to read the test image, and tests the operation state of the image forming portion 5 based on whether or not the test image is formed properly. Since the image forming portion 5 uses the inkjet system in the present embodiment, the test processing portion 71 tests an ink ejection state from the respective ink nozzles 53.

When an operational failure (an ink ejection failure) of the image forming portion 5 is detected by the test processing portion 71, the control device 7 executes countermeasure processing with respect to the operational failure. As an example of the countermeasure processing, the control device 7 corrects variations in ink ejection amounts from the plurality of ink nozzles 53 by shading correction or the like. Alternatively, when the ink ejection failure cannot be eliminated by merely changing the ink ejection amounts, the control device 7 may cancel the image forming operation by the image forming portion 5 as the countermeasure processing. In this case, as the countermeasure processing, the control device 7 may additionally cause a maintenance unit to perform a wiping operation or cause a display operation portion or the like to perform notification (display or the like) to prompt a user to perform maintenance (replacement of the recording head 51 or the like). The test processing portion 71 may be provided separate from the main control device 7 that collectively controls the image forming apparatus 10.

Furthermore, the image forming apparatus 10 further includes a head cooling device, the maintenance unit, a cap unit, an operation display portion, and the like. The head cooling device cools the recording heads 51. The maintenance unit performs a wiping operation for wiping the ink ejection surfaces (the lower surfaces of the recording heads 51) to clean the ink ejection surfaces. The cap unit covers the ink ejection surface of the recording head 51 to protect it from drying. The operation display portion is a user interface in the inkjet recording apparatus. The operation display portion includes a display portion such as a liquid crystal display that displays various types of information in response to control instructions from the control device 7 and an operation portion such as a switch and a touch panel used for inputting various types of information to the control device according to user operations.

### [2] Details of Test Processing Portion

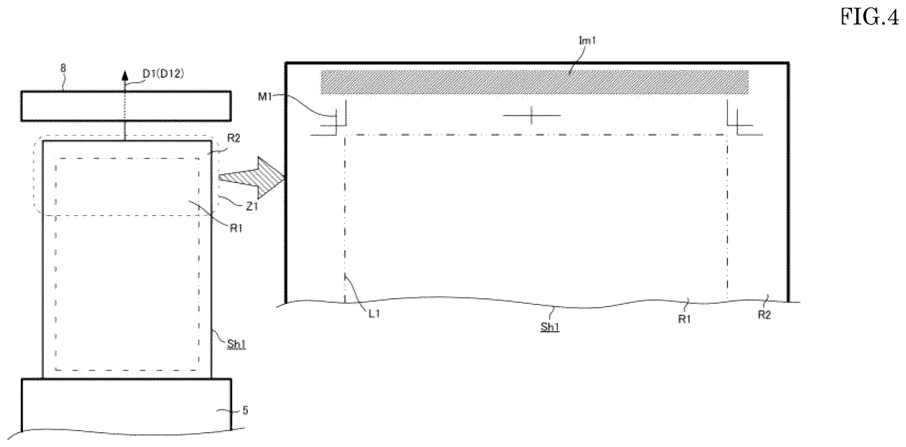

Next, the test processing portion 71 of the image forming apparatus 10 according to the present embodiment will be described in more detail with reference to FIG. 4 to FIG. 9. In the present embodiment, the test processing portion 71 provided in the control device 7 performs a test for an operational failure (an ink ejection failure) of the image forming portion 5 as described above.

Specifically, as shown in FIG. 4, the test processing portion 71 causes the image forming portion 5 to form a test image Im1 in a marginal region R2 of the sheet Sh1. Then, the test processing portion 71 causes the image reading portion 8 to read the test image Im1. FIG. 4 is a schematic diagram showing the sheet Sh1 conveyed by the main conveying unit 43 of the sheet conveying device 4 from above, and an enlarged diagram of a head-side portion (a range Z1) of the sheet Sh1 in the conveying direction D1 (the same as the sub-scanning direction D12) is shown on the right-hand side.

The sheet Sh1 includes a document sheet region R1 and the marginal region R2. The document sheet region R1 and the marginal region R2 are sectioned by a boundary line L1, and a region on an inner side of the boundary line L1 is the document sheet region R1, and a region on an outer side of the boundary line L1 is the marginal region R2. In FIG. 4 and the like, the boundary line L1 is indicated by an imaginary line (a dash-dot-dot line), but the boundary line L1 is not actually formed on the sheet Sh1. The document sheet region R1 is a region where a desired image is formed by the image forming portion 5. The marginal region R2 is a region that is not used for forming a desired image and is, for example, a region where trimming marks (printer marks) M1 for cutting, and the like are formed.

In other words, by forming the test image Im1 in such a marginal region R2, the test processing portion 71 uses the marginal region R2 to perform a test of the operation state of the image forming portion 5. More specifically, as shown on the left-hand side of FIG. 4, the image forming portion 5 forms the test image Im1 in the head-side marginal region R2 of the sheet Sh1 conveyed by the sheet conveying device 4 along the conveying direction D1. Then, the image reading portion 8 arranged on the downstream side of the image forming portion 5 reads the test image Im1 formed on the sheet Sh1, to enable the test processing portion 71 to perform the test.

The test processing portion 71 determines, for example, whether or not there is a defect that is due to an ink ejection failure, such as a dead pixel, in the read test image Im1, and when there is the defect, determines that an operational failure (an ink ejection failure) of the image forming portion 5 has occurred. In addition, the test processing portion 71 is capable of specifying which of the plurality of ink nozzles 53 has the ink ejection failure based on a position at which the defect has occurred in the test image Im1.

Incidentally, as the related art, there is known an image forming apparatus (an inkjet recording apparatus) having a function of detecting an ink ejection failure. In the image forming apparatus according to the related art, ink is ejected from each of a plurality of arranged nozzles onto a sheet (a recording medium), to thus form an image on the sheet. In this image forming apparatus, it is possible to adjust an ink ejection amount from adjacent nozzles based on a test result of an ink ejection state of the nozzles, to thus compensate for lowering of quality of a formed image that is due to the ink ejection failure of the nozzles.

In the image forming apparatus according to the related art, a test of the ink ejection state includes ejecting ink onto a sheet from a plurality of nozzles, forming a halftone image having a predetermined concentration on the sheet as a test image (a test image), and reading the test image. Then, this image forming apparatus determines whether or not there is an ink ejection failure of the nozzles based on a contrasting density of the read test image.

With the configuration of the related art, however, since a test image is formed by ejecting ink from all of the plurality of nozzles onto a single sheet, it likely takes time to form a test image on a single sheet, and an amount of consumption of consumables (ink) is likely to become large.

In contrast, in the image forming apparatus 10 according to the present embodiment, it is possible to realize the image forming apparatus 10 in which a time required for forming a test image is likely to be shortened and an amount of consumption of consumables is likely to be suppressed by a configuration described below.

Specifically, the image forming apparatus 10 according to the present embodiment includes the image forming portion 5, the image reading portion 8, and the test processing portion 71. The image forming portion 5 forms an image on the sheet Sh1 using a plurality of recording elements. The image reading portion 8 reads the image on the sheet Sh1. The test processing portion 71 causes the image forming portion 5 to form a test image Im1 in the marginal region R2 of the sheet Sh1 and causes the image reading portion 8 to read the test image Im1. Herein, the test processing portion 71 is capable of executing a divisional test in which only some of the plurality of recording elements are used for forming a single test image Im1 to be formed on a single sheet Sh1 and all of the plurality of recording elements are used for forming a test image group constituted of a plurality of test images Im1 to be formed on a plurality of sheets Sh1.

In the present embodiment, the ink nozzle 53 is an example of the recording element. In other words, the image forming portion 5 includes the plurality of ink nozzles 53 (the recording elements), and the plurality of ink nozzles 53 are used to form an image on the sheet Sh1. In the present embodiment in particular, as shown in FIG. 3, since each of the line heads 50 of the four colors includes three recording heads 51 in the image forming portion 5, a total of the plurality of ink nozzles 53 provided in the total of 12 recording heads 51 becomes a sum of the plurality of ink nozzles 53 (the recording elements) included in the image forming portion 5. The sum of the ink nozzles 53 as the recording elements included in the image forming portion 5 in this manner will hereinafter be also referred to as a “predetermined number”.

In short, in the divisional test, all of the predetermined number of ink nozzles 53 (recording elements) are used to form a test image group constituted of a plurality of test images Im1 on a plurality of sheets Sh1 instead of being used to form a single test image Im1 on a single sheet Sh1. In other words, in the divisional test, the test images Im1 that use all of the predetermined number of ink nozzles 53 (recording elements) are formed divisionally on the plurality of sheets Sh1 instead of being formed on a single sheet Sh1. Thus, the test for the predetermined number of ink nozzles 53 (recording elements) is performed using the plurality of sheets Sh1 instead of a single sheet Sh1.

Accordingly, in the image forming apparatus 10 according to the present embodiment, there are advantages that a time required for forming the test image Im1 on a single sheet Sh1 is likely to be shortened and an amount of consumption of consumables (ink) is likely to be suppressed as compared to the related art. In addition, since the test can be performed for all of the plurality of recording elements (ink nozzles 53) by the test image group divisionally formed on the plurality of sheets Sh1, the test can consequently be performed for the entire image forming portion 5 (the predetermined number of recording elements).

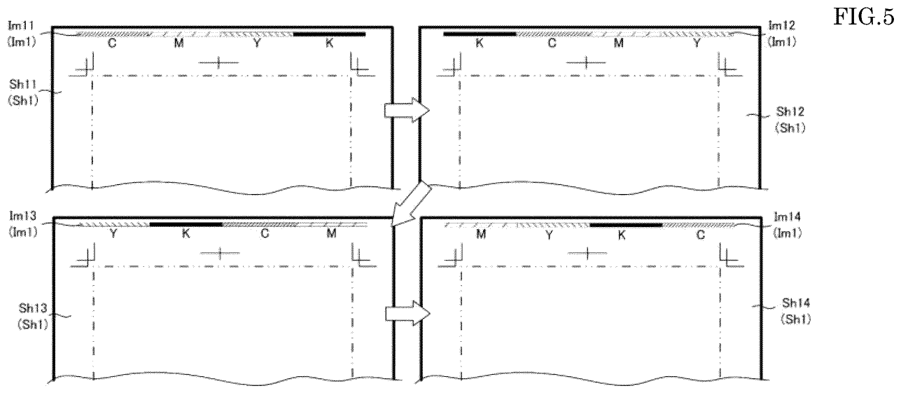

Hereinafter, specific examples of the test image Im1 that is used by the test processing portion 71 in the image forming apparatus 10 according to the present embodiment will be described with reference to FIG. 5 to FIG. 9. Herein, descriptions will be given on a case where a four-color printing machine that uses ink of the respective colors of black (K), cyan (C), magenta (M), and yellow (Y) is used as the image forming portion 5.

FIG. 5 shows a test image group of a first pattern. As shown in FIG. 5, the test image group of the first pattern includes four test images Im11 to Im14 that are formed divisionally on four sheets Sh11 to Sh14. Each of the test images Im11 to Im14 is divided into four in the main scanning direction D11 and is configured such that images of four colors are respectively arranged in the four regions obtained by the division. The test image Im11 formed on the first sheet Sh11 includes C, M, Y, and K in the stated order from the left-hand side, and the test image Im12 formed on the second sheet Sh12 includes K, C, M, and Y in the stated order from the left-hand side. The test image Im13 formed on the third sheet Sh13 includes Y, K, C, and M in the stated order from the left-hand side, and the test image Im14 formed on the fourth sheet Sh14 includes M, Y, K, and C in the stated order from the left-hand side.

The test processing portion 71 repetitively forms these four test images Im11 to Im14 every four sheets Sh11 to Sh14. The test image group of the first pattern is an ideal case where the number of ink colors and the number of test images Im1 constituting the test image group match.

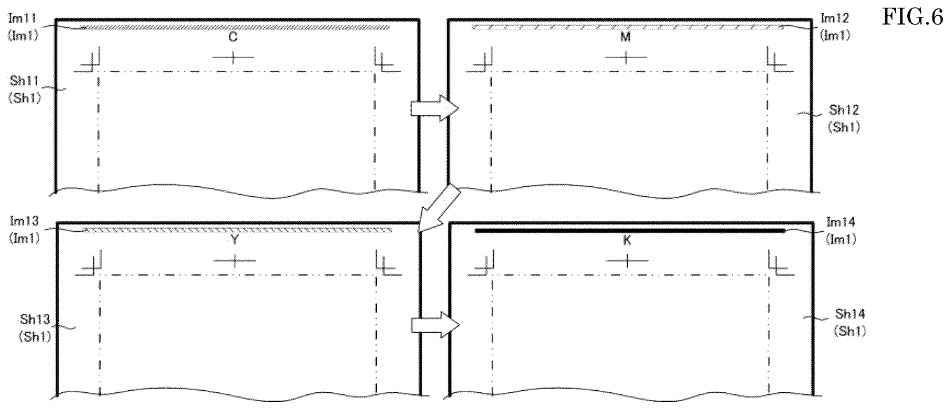

FIG. 6 shows a test image group of a second pattern. As shown in FIG. 6, the test image group of the second pattern includes four test images Im11 to Im14 that are formed divisionally on four sheets Sh11 to Sh14. The four test images Im11 to Im14 are images of the respective colors of C, M, Y, and K, respectively. The test image Im11 formed on the first sheet Sh11 is an image of C, the test image Im12 formed on the second sheet Sh12 is an image of M, the test image Im13 formed on the third sheet Sh13 is an image of Y, and the test image Im14 formed on the fourth sheet Sh14 is an image of K.

The test processing portion 71 repetitively forms these four test images Im11 to Im14 every four sheets Sh11 to Sh14. In the test image group of the second pattern, the test image Im1 of one color is formed for each sheet Sh1.

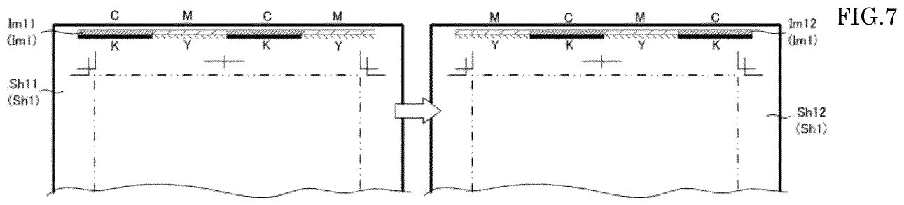

FIG. 7 shows a test image group of a third pattern. As shown in FIG. 7, the test image group of the third pattern includes two test images Im11 and Im12 that are formed divisionally on two sheets Sh11 and Sh12. Each of the test images Im11 and Im12 is divided into four in the main scanning direction D11 and is configured such that images of different colors are arranged in two rows in the sub-scanning direction D12. The test image Im11 formed on the first sheet Sh11 includes C, M, C, and M in the stated order from the left-hand side on the first row and includes K, Y, K, and Y in the stated order from the left-hand side on the second row. The test image Im12 formed on the second sheet Sh12 includes M, C, M, and C in the stated order from the left-hand side on the first row and includes Y, K, Y, and K in the stated order from the left-hand side on the second row.

The test processing portion 71 repetitively forms these two test images Im11 and Im12 every two sheets Sh11 and Sh12. In the test image group of the third pattern, the number of test images Im1 constituting the test image group becomes ½ of the number of ink colors.

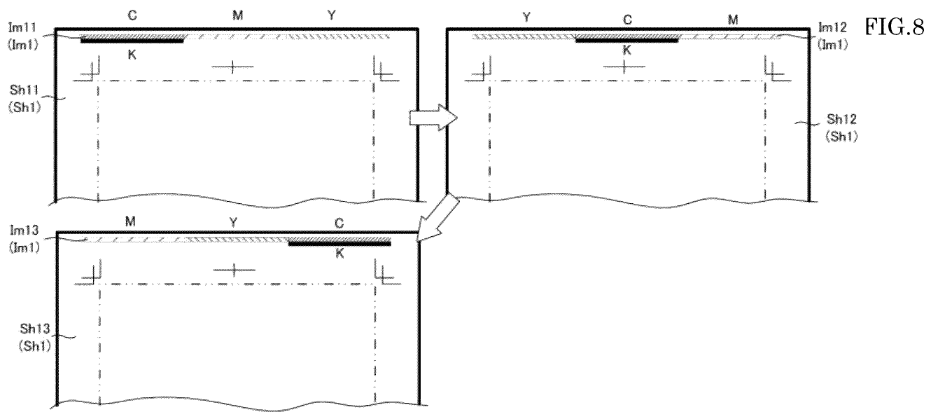

FIG. 8 shows a test image group of a fourth pattern. As shown in FIG. 8, the test image group of the fourth pattern includes three test images Im11 to Im13 that are formed divisionally on three sheets Sh11 to Sh13. Each of the test images Im11 to Im13 is divided into three in the main scanning direction D11 and is configured such that images of different colors are arranged in two rows in the sub-scanning direction D12. The test image Im11 formed on the first sheet Sh11 includes C, M, and Y in the stated order from the left-hand side on the first row and includes K at a left end of the second row. The test image Im12 formed on the second sheet Sh12 includes Y, C, and M in the stated order from the left-hand side on the first row and includes K at a center of the second row. The test image Im13 formed on the third sheet Sh13 includes M, Y, and C in the stated order from the left-hand side on the first row and includes K at a right end of the second row.

The test processing portion 71 repetitively forms these three test images Im11 to Im13 every three sheets Sh11 to Sh13. In the test image group of the fourth pattern, the number of test images Im1 constituting the test image group is smaller than the number of ink colors.

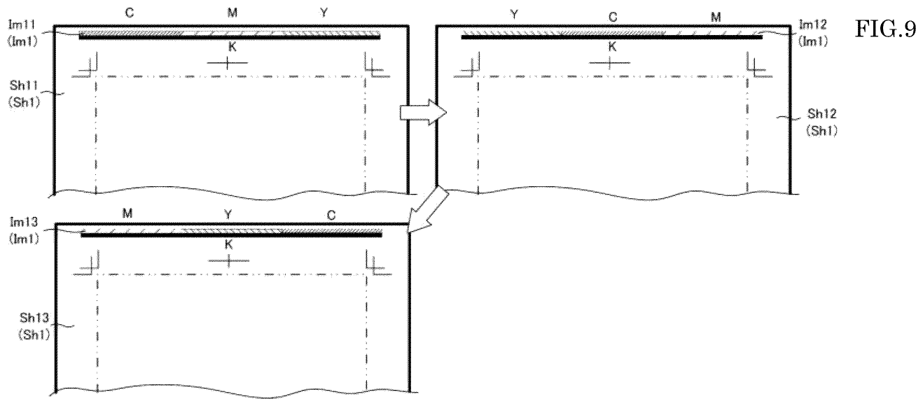

FIG. 9 shows a test image group of a fifth pattern. As shown in FIG. 9, the test image group of the fifth pattern includes three test images Im11 to Im13 that are formed divisionally on three sheets Sh11 to Sh13. Each of the test images Im11 to Im13 is divided into three in the main scanning direction D11 and is configured such that images of different colors are arranged in two rows in the sub-scanning direction D12. The test image Im11 formed on the first sheet Sh11 includes C, M, and Y in the stated order from the left-hand side on the first row and includes K on the second row. The test image Im12 formed on the second sheet Sh12 includes Y, C, and M in the stated order from the left-hand side on the first row and includes K on the second row. The test image Im13 formed on the third sheet Sh13 includes M, Y, and C in the stated order from the left-hand side on the first row and includes K on the second row.

The test processing portion 71 repetitively forms these three test images Im11 to Im13 every three sheets Sh11 to Sh13. In the test image group of the fifth pattern, the number of test images Im1 constituting the test image group is smaller than the number of ink colors. In this case, regarding the color that is used most frequently (for example, K), the test of all of the ink nozzles 53 can be performed in any of the three sheets Sh11 to Sh13.

In the image forming apparatus 10 according to the present embodiment, for example, the number of test images Im1 to be included in the test image group can be set as appropriate as in the first to fifth patterns. In other words, the test processing portion 71 can change the number of test images Im1 to be included in the test image group. Therefore, for example, it is possible to make a setting such that a test of a predetermined number of recording elements are ended using an appropriate number of sheets Sh1 according to a purpose, a use frequency, or the like of the image forming apparatus 10.

### [3] Image Forming Method

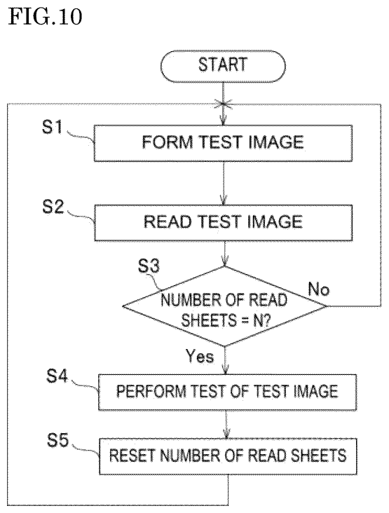

Hereinafter, the image forming method executed by the test processing portion 71 in the image forming apparatus 10 having the configuration described above will be described with reference to the flowchart shown in FIG. 10. Herein, Step S1, Step S2, . . . represent number of processing procedures (steps) executed by the test processing portion 71.

### <Step S1, Step S2>

First, in Step S1, the test processing portion 71 controls the image forming portion 5 to form a test image Im1 on a first sheet Sh1. In next Step S2, the test processing portion 71 controls the image reading portion 8 to read the test image Im1 from the first sheet Sh1.

### <Step S3>

In Step S3, the test processing portion 71 determines whether or not the number of sheets Sh1 from which the test images Im1 have been read in Step S2 (the number of read sheets) has reached a predetermined number of sheets N. Herein, the predetermined number of sheets N is the number of test images Im1 included in the test image group and is, for example, “N=4” in the test image group of the first pattern. Then, when the number of read sheets has reached the predetermined number of sheets N (S3: Yes), the test processing portion 71 shifts the processing to Step S4. On the other hand, when the number of read sheets has not reached the predetermined number of sheets N (S3: No), the test processing portion 71 shifts the processing back to Step S1.

### <Step S4, Step S5>

In Step S4, the test processing portion 71 executes a test for the test images Im1 for the predetermined number of sheets N. After that, in Step S5, the test processing portion 71 resets the number of read sheets (resets to “0”) and shifts the processing back to Step S1.

The procedures of the image forming method described heretofore are mere examples, and the order of the processing shown in the flowchart of FIG. 10 may be switched as appropriate, or appropriate processing may be added or omitted.

### [4] Modified Example

The plurality of constituent elements included in the image forming apparatus 10 may be provided dispersedly in a plurality of housings. For example, the image forming portion 5 and the ink supply portion 6 may be provided in different housings.

Conversely, in Embodiment 1, at least one of the constituent elements provided separate from the image forming apparatus 10 may be provided in the image forming apparatus 10 as a constituent element of the image forming apparatus 10. For example, at least one of the sheet feed apparatus 11, the drying apparatus 12, and the discharge apparatus 13 may be provided inside the housing 21, or the like, so as to be configured integrally with the image forming apparatus 10.

Moreover, the image forming target on which an image is to be formed in the image forming apparatus 10 is not limited to the sheet Sh1 such as paper and a resin film and may be, for example, roll-type fabric such as non-woven fabric and textile. In this case, the image forming apparatus 10 is a textile printing machine (a textile printer) which ejects ink onto the fabric and dyes fibers of the fabric by ink to record an image on the fabric.

In addition, the “recording elements” are not limited to the ink nozzles 53 and may be, for example, the recording heads 51 or the line heads 50. Further, if systems other than the inkjet system are used in the image forming apparatus 10, the recording elements are changed as appropriate according to the system of the image forming apparatus 10 and the like.

### Embodiment 2

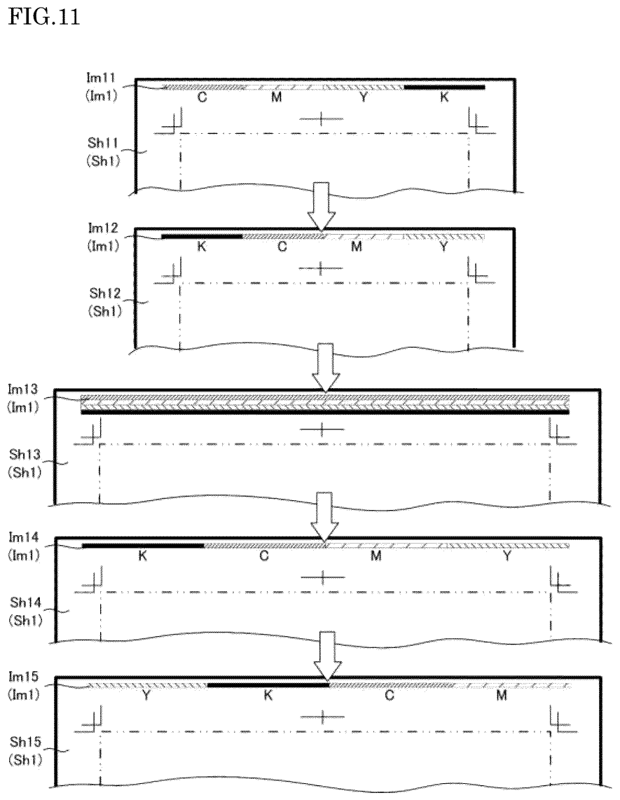

As shown in FIG. 11 to FIG. 13, the image forming apparatus 10 according to the present embodiment is different from the image forming apparatus 10 according to Embodiment 1 in the point of being compatible with a change in attribute of the sheet Sh1 in the middle of formation of the images on the plurality of sheets Sh1. Hereinafter, configurations similar to those of Embodiment 1 will be denoted by common symbols, and descriptions will be omitted as appropriate.

The attribute of the sheet Sh1 used herein includes, for example, a size (a paper sheet size), an orientation, and the like of the sheet Sh1. In the present embodiment, a case where the size of the sheet Sh1 is changed in mid-course is assumed as an example. Also in the present embodiment, a case where the test processing portion 71 executes the divisional test according to the test image group of the first pattern will be exemplified.

For example, as shown in FIG. 11, a case where, when forming images on the sheets Sh11 to Sh15, the sheets Sh11 and Sh12 of an “A4 size in portrait orientation” are changed to the sheets Sh13 to Sh15 of an “A3 size in portrait orientation” is assumed. In this case, for the sheets Sh11 and Sh12, the test processing portion 71 sequentially forms the test images Im11 and Im12 according to the test image group of the first pattern. Then, when the attribute (the size) of the sheet Sh1 is changed, the test processing portion 71 temporarily stops the divisional test and executes, on the sheet Sh13 positioned at the top after the change of the size, an overall test in which all of the predetermined number of ink nozzles 53 are used. In other words, the test image Im13 formed on the sheet Sh13 is an image that uses all of the plurality of ink nozzles 53 of C, M, Y, and K.

Then, for the second and subsequent sheets Sh14 and Sh15 after the change of the size, the test processing portion 71 sequentially forms the test images Im14 and Im15 according to the test image group of the first pattern, to resume the divisional test. Herein, the test images Im14 and Im15 formed on the sheets Sh14 and Sh15 are images obtained by expanding the images according to a width of the sheets Sh14 and Sh15 of the “A3 size in portrait orientation” as compared to the test images Im11 and Im12.

Specifically, in the image forming apparatus 10 according to the present embodiment, the test processing portion 71 changes a mode of the test image Im1 in sync with a timing at which the attribute of the sheet Sh1 is changed. Thus, even when the attribute of the sheet Sh1 is changed, it is difficult for testing quality to be lowered, and appropriate test processing tailored for the sheet Sh1 can be performed.

Particularly in the present embodiment, the test processing portion 71 executes, for the first sheet Sh1 after the change of the attribute, the overall test in which all of the plurality of recording elements (ink nozzles 53) are used for forming a single test image Im1 to be formed on a single sheet Sh1. Thus, the operation states of all of the predetermined number of recording elements can be guaranteed at a timing at which the attribute of the sheet Sh1 is changed. In addition, there are advantages that a time required for forming the test image Im1 on a single sheet Sh1 is likely to be shortened and an amount of consumption of consumables (ink) is likely to be suppressed as compared to the case of executing the overall test on all of the sheets Sh1.

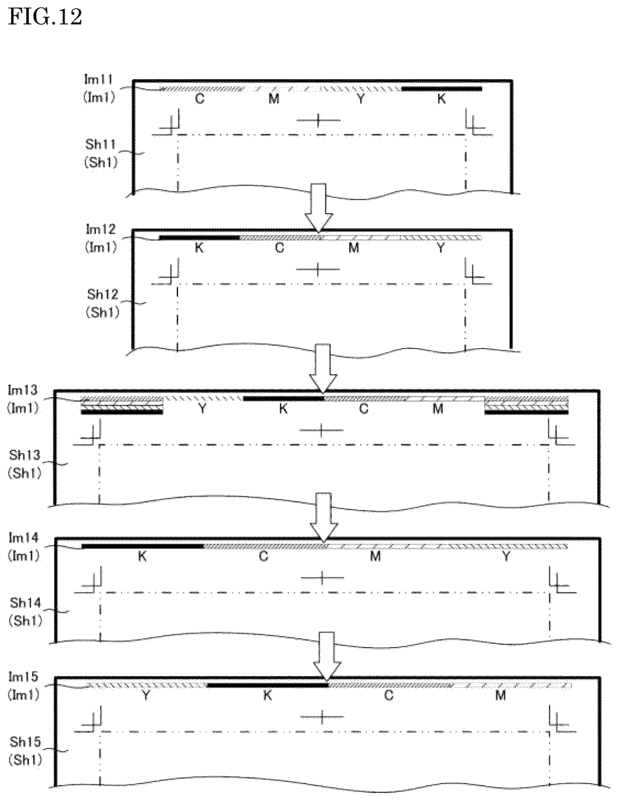

Alternatively, as another example, the test processing portion 71 is also capable of adopting a configuration in which the overall test is not performed at the timing at which the attribute of the sheet Sh1 is changed as shown in FIG. 12. In the example of FIG. 12, for the sheets Sh11 and Sh12, the test processing portion 71 sequentially forms the test images Im11 and Im12 according to the test image group of the first pattern. Then, when the attribute (the size) of the sheet Sh1 is changed, the test processing portion 71 forms the test image Im13 as exemplified in FIG. 12 on the sheet Sh13 positioned at the top after the change of the size. In the sheet Sh13, the test image Im13 includes images that use all of the plurality of ink nozzles 53 of C, M, Y, and K only in regions where the test has not been able to be performed in the sheets Sh11 and Sh12 before the change of the size. Herein, for the region already tested in the sheets Sh11 and Sh12 before the change of the size, the test image Im13 configures an image in which Y, K, C, and M are arranged in the stated order from the left-hand side according to the test image group of the first pattern.

Then, for the second and subsequent sheets Sh14 and Sh15 after the change of the size, the test processing portion 71 sequentially forms the test images Im14 and Im15 according to the test image group of the first pattern. Herein, the test images Im14 and Im15 formed on the sheets Sh14 and Sh15 are images obtained by expanding the images according to a width of the sheets Sh14 and Sh15 of the “A3 size in portrait orientation” as compared to the test images Im11 and Im12. In short, in the example of FIG. 12, the test processing portion 71 continuously executes the divisional test for the sheets Sh11 to Sh15 obtained both before the change of the size and after the change of the size.

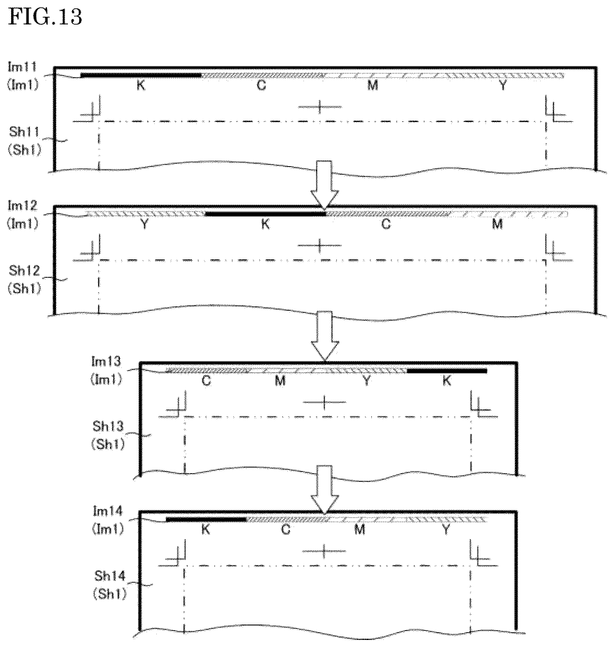

Furthermore, as shown in FIG. 13, when the size of the sheet Sh1 becomes small, the test processing portion 71 only needs to simply continue the divisional test without adding special processing. For example, as shown in FIG. 13, a case where, when forming images on the sheets Sh11 to Sh14, the sheets Sh11 and Sh12 of an “A3 size in portrait orientation” are changed to the sheets Sh13 and Sh14 of an “A4 size in portrait orientation” is assumed. In this case, for the sheets Sh11 and Sh12, the test processing portion 71 sequentially forms the test images Im11 and Im12 according to the test image group of the first pattern. Then, when the attribute (the size) of the sheet Sh1 is changed, the test processing portion 71 sequentially forms the test images Im13 and Im14 according to the test image group of the first pattern also for the sheets Sh13 and Sh14 obtained after the change of the size. It is noted that the test images Im13 and Im14 formed on the sheets Sh13 and Sh14 are images obtained by contracting the images according to a width of the sheets Sh13 and Sh14 of the “A4 size in portrait orientation” as compared to the test images Im11 and Im12.

Herein, the case where the attribute of the sheet Sh1 is changed between the sheet Sh1 of the “A3 size in portrait orientation” and the sheet Sh1 of the “A4 size in portrait orientation” has been exemplified, but the same holds true also for other attributes of the sheet Sh1.

### Embodiment 3

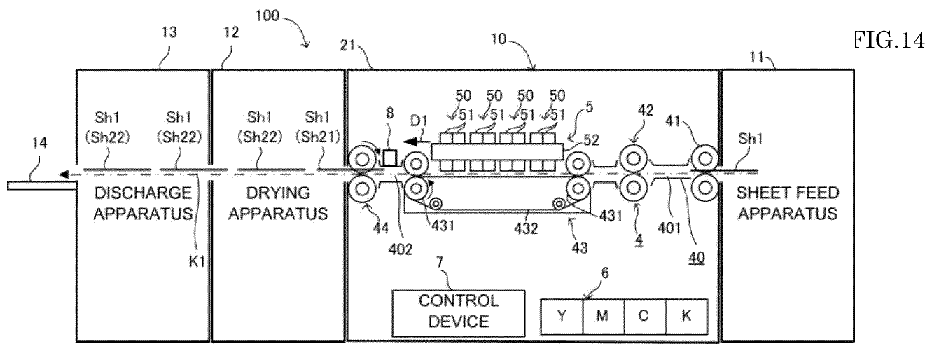

In the image forming system 100 according to the present embodiment (an example of the image forming apparatus according to the present disclosure), the sheet feed apparatus 11, the sheet conveying device 4 of the image forming apparatus 10, the drying apparatus 12, and the discharge apparatus 13 function as a sheet conveying portion which conveys the sheet Sh1 along a conveying path K1 (see FIG. 14) that reaches a first discharge portion 14 (see FIG. 14) that is a discharge destination of the sheet Sh1 via the image forming portion 5. For example, the first discharge portion 14 is a sheet discharge tray. Further, in the image forming system 100 according to the present embodiment, the processing content of the test processing portion 71 differs from that of the image forming apparatus 10 according to Embodiment 1. Hereinafter, configurations similar to those of Embodiment 1 will be denoted by common symbols, and descriptions will be omitted as appropriate.

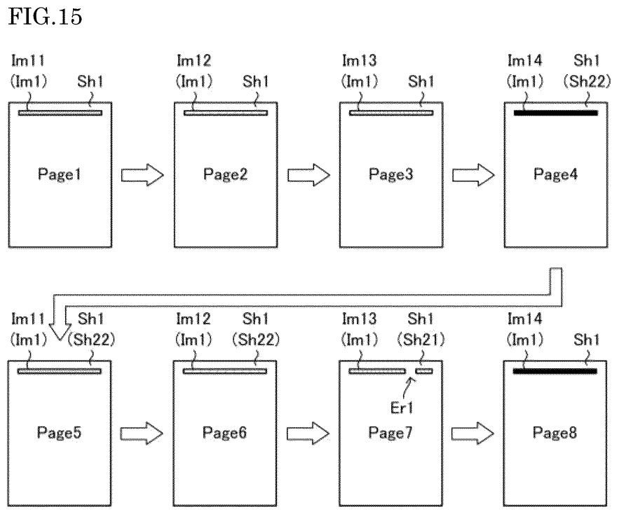

In the divisional processing according to the present embodiment, the test images Im1 included in the test image group are formed periodically. In addition, in the divisional processing according to the present embodiment, one of the test images Im1 is formed every time an image (a page image) is formed in the document sheet region R1 of the sheet Sh1 as shown in FIG. 15. In other words, in the divisional processing according to the present embodiment, the plurality of test images Im1 included in the test image group are sequentially formed at intervals of image formation by the image forming portion 5 in the document sheet regions R1 of the sheets Sh1. For example, when the number of test images Im1 included in the test image group is four, the four test images Im11 to Im14 are formed in the order of the test image Im11, the test image Im12, the test image Im13, the test image Im14, the test image Im11, . . . at the intervals of image formation by the image forming portion 5 in the document sheet regions R1 of the sheets Sh1 as shown in FIG. 15. It is noted that FIG. 15 exemplifies a case where the divisional test is executed according to the test image group of the second pattern.

Further, the test processing portion 71 according to the present embodiment tests the read test image Im1 every time the test image Im1 included in the test image group is read by the image reading portion 8. Then, when determined that there is a defect in the test image Im1, the test processing portion 71 notifies to that effect and also discharges, in an identifiable manner, a specific sheet including a sheet surface on which an image is formed next after a sheet surface including the test image Im1 obtained one cycle before the test image Im1 that has been determined as having the defect. The sheet surface may include only a front surface of a sheet, or may include both front and back surfaces of a sheet.

Specifically, the test processing portion 71 notifies that the test image Im1 has been determined as having a defect at a timing at which the specific sheet is discharged to the first discharge portion 14.

For example, it is assumed that, when sequentially forming page images of first to eighth pages as shown in FIG. 15, the test image Im13 formed together with the page image of the seventh page includes a defective image Er1 such as a white streak. In this case, the test processing portion 71 determines that the sheet Sh1 including the sheet surface on which an image is formed next after the sheet surface including the test image Im13 obtained one cycle before the test image Im13 including the defective image Er1 (the test image Im13 formed together with the page image of the third page) (the sheet surface on which the page image of the fourth page is formed) is the specific sheet. In other words, the test processing portion 71 determines that, while an operational failure has not occurred in the image forming portion 5 when forming the test image Im13 obtained one cycle before the test image Im13 including the defective image Er1, the operational failure may have occurred in the image forming portion 5 when forming an image of the next page, and discharges the specific sheet that might be including the defective image in an identifiable manner.

Moreover, the test processing portion 71 according to the present embodiment sets the number of test images Im1 to be included in the test image group based on the number of sheets Sh1 not yet discharged, that are present in a section more on the downstream side than the sheet Sh1 including the test image Im1 as the test target on the conveying path K1 at the time of the test of the test image Im1.

For example, in the image forming system 100, it is assumed that the number of sheets Sh1 not yet discharged (Sh22), that are present in the section more on the downstream side than the sheet Sh1 including the test image Im1 as the test target (Sh21) on the conveying path K1 at the time of the test of the test image Im1 is three (see FIG. 14). In this case, the test processing portion 71 sets “4” obtained by adding “1” to the number of sheets Sh1 not yet discharged (Sh22) as the number of test images Im1 to be included in the test image group. Thus, when it is determined that there is a defect in the test image Im13 formed on the sheet Sh21 as shown in FIG. 15, the specific sheet (the sheet Sh22 on which the page image of the fourth image is formed) can be set to a not-yet-discharged state. It is noted that the number of sheets Sh1 not yet discharged, that are present in the section more on the downstream side than the sheet Sh1 including the test image Im1 as the test target on the conveying path K1 at the time of the test of the test image Im1 can be specified based on a length of the section, a size of the sheet Sh1 to be conveyed, and intervals among the sheets Sh1 during the conveyance.

It is noted that the test processing portion 71 may set a number that is equal to or smaller than the number of sheets Sh1 not yet discharged, that are present in the section more on the downstream side than the sheet Sh1 including the test image Im1 as the test target on the conveying path K1 at the time of the test of the test image Im1 as the number of test images Im1 to be included in the test image group.

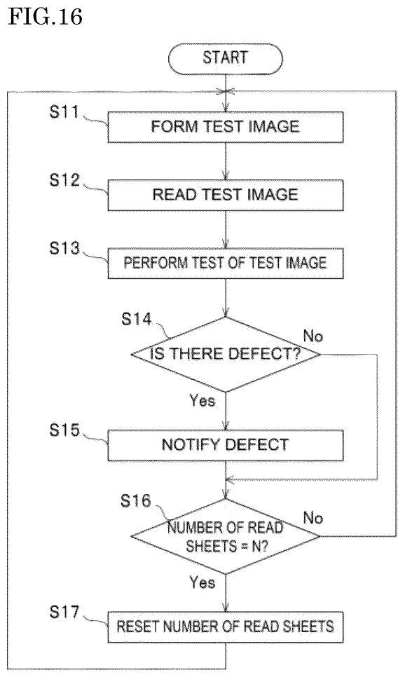

Hereinafter, the image forming method executed by the test processing portion 71 in the image forming system 100 having the configuration described above will be described with reference to the flowchart shown in FIG. 16.

### <Step S11, Step S12>

First, in Step S11, the test processing portion 71 controls the image forming portion 5 to form a test image Im1 on a first sheet Sh1. In next Step S12, the test processing portion 71 controls the image reading portion 8 to read the test image Im1 from the first sheet Sh1.

### <Step S13>

In Step S13, the test processing portion 71 executes a test for the test image Im1 read in Step S12.

### <Step S14>

In Step S14, the test processing portion 71 determines whether or not a defect has been detected in the test executed in Step S13. Then, when determining that a defect has been detected (S14: Yes), the test processing portion 71 shifts the processing to Step S15. On the other hand, when determining that a defect has not been detected (S14: No), the test processing portion 71 shifts the processing to Step S16.

### <Step S15>

In Step S15, the test processing portion 71 notifies that the test image Im1 has been determined as having a defect, and discharges, in an identifiable manner, the specific sheet including a sheet surface on which an image is formed next after a sheet surface including the test image Im1 obtained one cycle before the test image Im1 that has been determined as having the defect.

Specifically, the test processing portion 71 notifies that the test image Im1 has been determined as having a defect, that is, an operational failure has occurred in the image forming portion 5, at a timing at which the specific sheet is discharged. For example, the test processing portion 71 causes the operation display portion of the image forming apparatus 10 to display a message notifying that the operational failure has occurred in the image forming portion 5. Thus, a user of the image forming system 100 can easily specify the first sheet Sh1 that might be including a defective image.

### <Step S16>

In Step S16, the test processing portion 71 determines whether or not the number of sheets Sh1 from which the test images Im1 have been read in Step S12 (the number of read sheets) has reached the predetermined number of sheets N. Then, when the number of read sheets has reached the predetermined number of sheets N (S16: Yes), the test processing portion 71 shifts the processing to Step S17. On the other hand, when the number of read sheets has not reached the predetermined number of sheets N (S16: No), the test processing portion 71 shifts the processing back to Step S11.

### <Step S17>

In Step S17, the test processing portion 71 resets the number of read sheets (resets to “0”) and shifts the processing back to Step S11. The processing of Step S11 to Step S17 is an example of a test step according to the present disclosure.

It is noted that the test processing portion 71 may set the number of test images Im1 to be included in the test image group according to a predetermined user operation. In other words, the number of test images Im1 to be included in the test image group can be set arbitrarily by the user.

In this case, when the number of test images Im1 to be included in the test image group, that is set by the user operation, exceeds a first specific number that is based on the number of sheets Sh1 not yet discharged, that are present in the section more on the downstream side than the sheet Sh1 including the test image Im1 as the test target on the conveying path K1 at the time of the test of the test image Im1, the test processing portion 71 may notify to that effect. The first specific number is a number obtained by adding “1” to the number of sheets Sh1 not yet discharged, that are present in the section more on the downstream side than the sheet Sh1 including the test image Im1 as the test target on the conveying path K1 at the time of the test of the test image Im1. Thus, it is possible to notify the user that it is impossible to notify that an operational failure has occurred in the image forming portion 5 at the discharge timing of the first sheet Sh1 that might be including a defective image.

### Embodiment 4

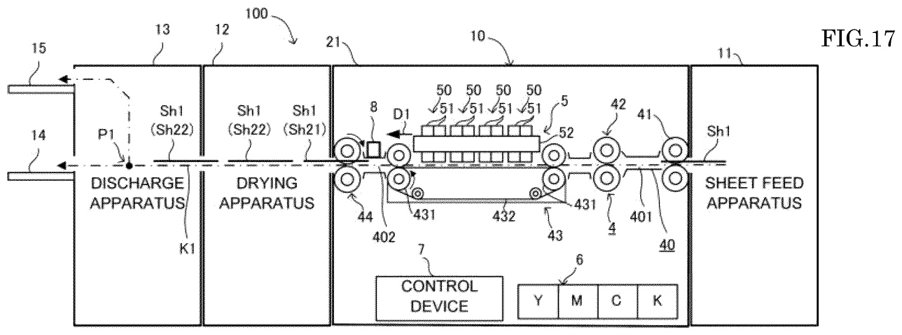

As shown in FIG. 17, the image forming system 100 according to the present embodiment is different from the image forming system 100 according to Embodiment 3 in the point of including a second discharge portion 15 in addition to the first discharge portion 14. For example, the second discharge portion 15 is a sheet discharge tray. Further, in the image forming system 100 according to the present embodiment, the processing content of the test processing portion 71 differs from that of the image forming system 100 according to Embodiment 3. Hereinafter, configurations similar to those of Embodiment 3 will be denoted by common symbols, and descriptions will be omitted as appropriate.

Instead of notifying that the test image Im1 has been determined as having a defect at the timing at which the specific sheet is discharged, the test processing portion 71 according to the present embodiment switches the discharge destination of the specific sheet and subsequent sheets Sh1 from the first discharge portion 14 to the second discharge portion 15.

In addition, the test processing portion 71 according to the present embodiment sets the number of test images Im1 to be included in the test image group based on the number of sheets Sh1 not yet discharged, that are present in a section up to a branching position P1 (see FIG. 17) between a conveying path that reaches the first discharge portion 14 and a conveying path that reaches the second discharge portion 15, the section being more on the downstream side than the sheet Sh1 including the test image Im1 as the test target on the conveying path K1 at the time of the test of the test image Im1.

For example, in the image forming system 100, it is assumed that the number of sheets Sh1 not yet discharged (Sh22), that are present in the section up to the branching position P1, the section being more on the downstream side than the sheet Sh1 including the test image Im1 as the test target (Sh21) on the conveying path K1 at the time of the test of the test image Im1, is two (see FIG. 17). In this case, the test processing portion 71 sets “3” obtained by adding “1” to the number of sheets Sh1 not yet discharged (Sh22) as the number of test images Im1 to be included in the test image group. Thus, when it is determined that there is a defect in the test image Im1 formed on the sheet Sh21, the discharge destination of the specific sheet can be switched. It is noted that in the image forming system 100, the number of sheets Sh1 not yet discharged, that are present in the section up to the branching position P1, the section being more on the downstream side than the sheet Sh1 including the test image Im1 as the test target on the conveying path K1 at the time of the test of the test image Im1, can be specified based on a length of the section, a size of the sheet Sh1 to be conveyed, and intervals among the sheets Sh1 during the conveyance.

It is noted that the test processing portion 71 may set the number of test images Im1 to be included in the test image group according to a predetermined user operation.

In this case, when the number of test images Im1 to be included in the test image group, that is set by the user operation, exceeds a second specific number that is based on the number of sheets Sh1 not yet discharged, that are present in the section up to the branching position P1, the section being more on the downstream side than the sheet Sh1 including the test image Im1 as the test target on the conveying path K1 at the time of the test of the test image Im1, the test processing portion 71 may notify to that effect. The second specific number is a number obtained by adding “1” to the number of sheets Sh1 not yet discharged, that are present in the section up to the branching position P1, the section being more on the downstream side than the sheet Sh1 including the test image Im1 as the test target on the conveying path K1 at the time of the test of the test image Im1. Thus, it is possible to notify the user that it is impossible to discharge, in the identifiable manner, the first sheet Sh1 that might be including a defective image and the subsequent sheets Sh1.

### Notes of Disclosure

Hereinafter, a general outline of the disclosure extracted from the embodiments described above will be noted. It is noted that the respective configurations and processing functions described in the notes below can be sorted and arbitrarily combined as appropriate.

### Note 1

An image forming apparatus, including:
an image forming portion which forms an image on a sheet using a plurality of recording elements;
an image reading portion which reads the image on the sheet; and
a test processing portion which causes the image forming portion to form a test image in a marginal region of the sheet, and causes the image reading portion to read the test image, in which
the test processing portion is capable of executing a divisional test in which only some of the plurality of recording elements are used for forming a single test image to be formed on a single sheet and all of the plurality of recording elements are used for forming a test image group constituted of a plurality of the test images to be formed on a plurality of the sheets.

### Note 2

The image forming apparatus according to note 1, in which the test processing portion is capable of changing a number of the test images to be included in the test image group.

### Note 3

The image forming apparatus according to note 1 or 2, in which the test processing portion changes a mode of the test image in sync with a timing at which an attribute of the sheet is changed.

### Note 4

The image forming apparatus according to note 3, in which the test processing portion executes, for a first sheet among the sheets after the change of the attribute, an overall test in which all of the plurality of recording elements are used for forming a single test image to be formed on a single sheet.

### Note 5

The image forming apparatus according to any one of notes 1 to 4, further including
a sheet conveying device which conveys the sheet, in which the image reading portion is arranged more on a downstream side of a conveying direction of the sheet than the image forming portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image forming portion which forms an image on a sheet using a plurality of recording elements;
an image reading portion which reads the image on the sheet; and
a test processing portion which causes the image forming portion to form a test image in a marginal region of the sheet, and causes the image reading portion to read the test image, wherein
the test processing portion is capable of executing a divisional test in which only some of the plurality of recording elements are used for forming a single test image to be formed on a single sheet and all of the plurality of recording elements are used for forming a test image group constituted of a plurality of the test images to be formed on a plurality of the sheets.

2. The image forming apparatus according to claim 1, wherein
the test processing portion is capable of changing a number of the test images to be included in the test image group.

3. The image forming apparatus according to claim 1, wherein
the test processing portion changes a mode of the test image in sync with a timing at which an attribute of the sheet is changed.

4. The image forming apparatus according to claim 3, wherein
the test processing portion executes, for a first sheet among the sheets after the change of the attribute, an overall test in which all of the plurality of recording elements are used for forming a single test image to be formed on a single sheet.

5. The image forming apparatus according to claim 1, further comprising
a sheet conveying device which conveys the sheet, wherein
the image reading portion is arranged more on a downstream side of a conveying direction of the sheet than the image forming portion.

6. The image forming apparatus according to claim 1, further comprising
a sheet conveying portion which conveys the sheet along a conveying path that reaches a discharge destination of the sheet via the image forming portion, wherein
in the divisional test, each of the test images included in the test image group is formed periodically, and
the test processing portion tests the test image every time the test image included in the test image group is read by the image reading portion, and when it is determined that there is a defect in the test image, notifies to that effect and discharges, in an identifiable manner, a specific sheet including a sheet surface on which an image is formed next after a sheet surface including the test image obtained one cycle before the test image determined as having a defect.

7. The image forming apparatus according to claim 6, wherein
the test processing portion notifies that the test image has been determined as having a defect at a timing at which the specific sheet is discharged.

8. The image forming apparatus according to claim 7, wherein
the test processing portion sets a number of the test images to be included in the test image group based on a number of the sheets not yet discharged, that are present more on a downstream side than the sheet including the test image as a test target on the conveying path at a time of the test of the test image.

9. The image forming apparatus according to claim 7, wherein
when a number of the test images to be included in the test image group, that is set by a user operation, exceeds a first specific number that is based on a number of the sheets not yet discharged, that are present more on a downstream side than the sheet including the test image as a test target on the conveying path at a time of the test of the test image, the test processing portion notifies to that effect.

10. The image forming apparatus according to claim 6, wherein
the test processing portion switches the discharge destination of the sheet for the specific sheet and subsequent sheets from a first discharge portion to a second discharge portion.

11. The image forming apparatus according to claim 10, wherein
the test processing portion sets a number of the test images to be included in the test image group based on a number of the sheets not yet discharged, that are present in a section up to a branching position between a conveying path that reaches the first discharge portion and a conveying path that reaches the second discharge portion, the section being more on a downstream side than the sheet including the test image as a test target on the conveying path at a time of the test of the test image.

12. The image forming apparatus according to claim 10, wherein
when a number of the test images to be included in the test image group, that is set by a user operation, exceeds a second specific number that is based on a number of the sheets not yet discharged, that are present in a section up to a branching position between a conveying path that reaches the first discharge portion and a conveying path that reaches the second discharge portion, the section being more on a downstream side than the sheet including the test image as a test target on the conveying path at a time of the test of the test image, the test processing portion notifies to that effect.

13. An image forming method, comprising:
image forming processing for causing an image forming portion which forms an image on a sheet using a plurality of recording elements to form a test image in a marginal region of the sheet; and
image reading processing for reading the test image, wherein
in the image forming processing, only some of the plurality of recording elements are used for forming a single test image to be formed on a single sheet, and all of the plurality of recording elements are used for forming a test image group constituted of a plurality of the test images to be formed on a plurality of the sheets.
